(19) United States
(12) Patent Application Publication
(10) Pub. No.: US 2011/0284354 A1
(43) Pub. Date: Nov. 24, 2011

(54) KEY ILLUMINATION SWITCH MODULE AND LIGHT GUIDE SHEET

(75) Inventors: Tomonobu Kato, Shiga (JP); Yasuhiro Tomisaka, Shiga (JP); Toshimitsu Fujiwara, Shiga (JP); Toshihiro Nimura, Osaka (JP)

(73) Assignee: OMRON CORPORATION, Kyoto-shi, Kyoto (JP)

(21) Appl. No.: 12/935,295

(22) PCT Filed: Mar. 17, 2009
(86) PCT No.: PCT/JP2009/001186

§ 371 Date: Dec. 23, 2010

(30) Foreign Application Priority Data
Apr. 1, 2008 (JP) 2008-094549 2008

(51) Int. Cl. H01H 5/18; G02B 6/00

(52) U.S. Cl. 200/406; 362/551

(57) ABSTRACT

A key illumination switch module has a cover sheet that includes an adhesive layer in a rear surface thereof, a dome-shaped contact spring whose apex portion is bonded to a rear surface of the cover sheet by the adhesive layer, a board that includes a first fixed contact and a second fixed contact, the first fixed contact and the second fixed contact being switched between a conducting state and an insulated state by the contact spring, a light guide sheet that is disposed on a surface side of the cover sheet. In the light guide sheet, a through-hole is made at a position corresponding to the apex portion of the contact spring.

### TECHNICAL FIELD

The present invention relates to a key illumination switch module and a light guide sheet. Specifically the present invention relates to a key illumination switch module used in a key illumination switch that is used while incorporated in a mobile telephone, a digital audio and the like and a light guide sheet used in the key illumination switch module.

### BACKGROUND ART

A key switch is used in a mobile telephone and the like. In a structure of the key switch, a key is pressed by a finger to deform a contact spring on a rear surface side of the key, and electric conduction is established between contact portions by the contact spring to turn on a switch. In such key switches, there is called a key illumination switch in which a key array surface can be illuminated from the rear surface side.

For example, FIG. 2 of Patent Document 1 discloses a key illumination switch. In the key illumination switch, a dome-shaped contact spring is disposed such that a fixed contact on a board is covered therewith, and an insulating sheet and an EL sheet are stacked on the contact spring, and the keys are provided on the insulating sheet and the EL sheet. The key array surface is illuminated by emission of the EL sheet.

When the insulating sheet and the EL sheet are stacked on the contact spring, a click feeling is degraded when the key is pressed to elastically deform the contact spring. Therefore, in the key illumination switch of Patent Document 1, as illustrated in FIGS. 1 and 2 of Patent Document 1, arc-shaped notches are formed in the insulating sheet and the EL sheet on both sides of the contact spring so as to sandwich the contact spring, and a restraint of the contact spring is weakened to achieve the improvement of the click feeling.

Patent Document 1: Japanese Unexamined Patent Publication No. 2002-56737

### SUMMARY OF THE INVENTION

However, in the key switch disclosed in Patent Document 1, a whole apex portion of the contact spring is bonded to rear surfaces of the insulating sheet and EL sheet. Therefore, an effect that the slit is formed in the insulating sheet and the EL sheet is reduced in an outer peripheral portion of the contact spring, and the effect that the click feeling is improved by the notches becomes small.

When the notches disclosed in Patent Document 1 are provided in the key illumination switch in which not the EL sheet but the light guide sheet is used, unfortunately evenness of emission luminance is reduced in the light guide sheet. That is, when the arc-shaped notches are provided on both sides of the contact spring so as to sandwich the contact spring in the outer peripheral portion of the contact spring, the evenness of the emission luminance is reduced because the notches interfere with the light guided in the light guide sheet. In particular, because the notches are provided so as to surround the contact spring, the light hardly enters the point of the contact spring surrounded by the notches, which causes the luminance to be reduced at the key position.

One or more embodiments of the invention provides a key illumination switch module in which the whole surface in which the keys are arrayed can evenly be illuminated while an excellent click feeling is obtained during the key manipulation and a light guide sheet used for the key illumination switch module.

A key illumination switch module according to a first aspect of the present invention includes a cover sheet that includes an adhesive layer in a rear surface thereof; a dome-shaped contact spring whose apex portion is bonded to a rear surface of the cover sheet by the adhesive layer; a board that includes a first fixed contact and a second fixed contact, the first fixed contact and the second fixed contact being switched between a conducting state and an insulated state by the contact spring; and a light guide sheet that is disposed on a surface side of the cover sheet, wherein, in the light guide sheet, a through-hole is made at a position corresponding to the apex portion of the contact spring.

In the key illumination switch module according to the first aspect of the present invention, because the through-hole is made at the position corresponding to the apex portion of the contact spring of the light guide sheet, the light guide sheet is easily bent at the point corresponding to the apex portion of the contact spring, and the click feeling becomes good when the contact spring is pressed from above the light guide sheet. Additionally, because the through-hole is made only at the position corresponding to the apex portion of the contact spring, the through-hole can be reduced, and the through-hole hardly interferes with the light guided in the light guide sheet. Therefore, even if the through-hole is made in the light guide sheet in order to improve the click feeling, the light can evenly be spread into the whole of the light guide sheet, and the light can be output from the outgoing surface to achieve the evenness of emission intensity.

A key illumination switch module according to a second aspect of the present invention includes a light guide sheet that includes an adhesive layer in a rear surface thereof; a dome-shaped contact spring whose apex portion is bonded to the rear surface of the light guide sheet by the adhesive layer; and a board that includes a first fixed contact and a second fixed contact, the first fixed contact and the second fixed contact being switched between a conducting state and an insulated state by the contact spring, wherein, in the light guide sheet, a through-hole is made at a position corresponding to the apex portion of the contact spring.

In the key illumination switch module according to the second aspect of the present invention, because the through-hole is made at the position corresponding to the apex portion of the contact spring of the light guide sheet, the light guide sheet is easily bent at the point corresponding to the apex portion of the contact spring, and the click feeling becomes good when the contact spring is pressed from above the light guide sheet. Additionally, because the through-hole is made only at the position corresponding to the apex portion of the contact spring, the through-hole can be reduced, and the through-hole hardly interferes with the light guided in the light guide sheet. Therefore, even if the through-hole is made in the light guide sheet in order to improve the click feeling, the light can evenly be spread into the whole of the light guide sheet, and the light can be output from the outgoing surface to achieve the evenness of emission intensity.

In the key illumination switch module according to the first or second aspect of the present invention, the through-hole may be made by slit processing. Accordingly, because the through-hole is made by the slit processing and formed by the slit hole, even if the light leaks to the outside from the inner surface of the through-hole, the light can be incident to the light guide sheet again from the opposite surface in the through-hole. Therefore, the through-hole hardly interferes with the light guided in the light guide sheet, and the evenness of the emission intensity is achieved.

Specifically, it is desirable that the through-hole made by the slit processing has a gap between sidewall surfaces located opposite each other in the through-hole. When the gap is provided between the sidewall surfaces of the through-hole made by the slit processing, the sidewall surfaces of the through-hole hardly graze with each other when the light guide sheet is pressed by the key, and a wear scrap is hardly generated. Therefore, generation of a conduction defect that is caused by the wear scrap caught in the contact spring or a contact portion of the board can be prevented.

In the key illumination switch module according to the first or second aspect of the present invention, the through-hole may be made into a cross shape by slit processing. Accordingly, because the through-hole is made into the cross shape by the slit processing, even if the light leaks to the outside from the inner surface of the through-hole, the light can be incident to the light guide sheet again from the opposite surface in the through-hole. Therefore, the through-hole hardly interferes with the light guided in the light guide sheet, and the evenness of the emission intensity is achieved. Because the through-hole has the cross shape, the light guide sheet is easily bent around the through-hole, the click feeling is further improved when the contact spring is pressed.

In the key illumination switch module according to the first or second aspect of the present invention, a slit length of the cross-shaped through-hole made by slit processing may range from 0.1 mm to 4 mm. When the slit length of the through-hole is larger than 4 mm, the through-hole becomes conspicuous from the front face of the key illumination switch module, and the key illumination switch module looks unattractive. Therefore, desirably the slit length of the through-hole is equal to or lower than 4 mm. Currently forming accuracy of the slit-shaped through-hole is about 0.1 mm.

In the key illumination switch module according to the first or second aspect of the present invention, a center of the through-hole may fall within a circular region when viewed from a direction perpendicular to the light guide sheet, an apex of the contact spring being set to a center of the circular region, a radius of the circular region being set to a length 3/20 times a diameter of the contact spring. According to the measurement result, when the center of the slit falls within the range, the high click rate can be maintained even if the position of the light guide sheet (slit) is deviated.

In the key illumination switch module according to the first or second aspect of the present invention, a diameter of a circle circumscribed to the through-hole may be smaller than a diameter of the contact spring when viewed from a direction perpendicular to the light guide sheet. According to the measurement result, because the click rate is reduced when the diameter of the circle circumscribed to the through-hole is larger than the diameter of the contact spring, desirably the diameter of the circle circumscribed to the through-hole is smaller than the diameter of the contact spring.

In the key illumination switch module according to the first or second aspect of the present invention, a light shielding treatment may be performed to a sidewall surface in the through-hole. Accordingly, the stray light caused by the light reflected or refracted by the sidewall surface of the through-hole can be prevented from degrading the luminance evenness.

In the key illumination switch module according to the first or second aspect of the present invention, a sheet thickness of a region corresponding to the through-hole in the light guide sheet may range from 0.1 times to 0.9 times a sheet thickness of a region located far away from the region corresponding to the through-hole. The portion located opposite the contact spring of the light guide sheet can further easily be bent by providing a thin-wall portion having the above-described thickness in the light guide sheet, so that the click feeling can further be improved.

In a light guide sheet according to a third aspect of the present invention, a through-hole is made by slit processing.

In the light guide sheet according to the third aspect of the present invention, because the through-hole is made by the slit processing, even if the light leaks to the outside from the inner surface of the through-hole, the light can be incident to the light guide sheet again from the opposite surface in the through-hole. Therefore, the through-hole hardly interferes with the light guided in the light guide sheet, and the evenness of the emission intensity is achieved.

In the light guide sheet according to the third aspect of the present invention, the through-hole made by the slit processing may have a gap between sidewall surfaces located opposite each other in the through-hole, the gap ranging from 0.1 mm to 0.5 mm. Accordingly, the sidewall surfaces of the through-hole hardly graze with each other, so that the generation of the wear scrap can be suppressed to prevent the conduction defect of the contact. When the gap ranges from 0.1 mm to 0.5 mm, the look and the click feeling can be improved in illuminating the key array surface, and productivity is also excellent.

In the light guide sheet according to the third aspect of the present invention, the through-hole may be made into a cross shape by slit processing. Accordingly, because the through-hole is made into the cross shape by the slit processing, even if the light leaks to the outside from the inner surface of the through-hole, the light can be incident to the light guide sheet again from the opposite surface in the through-hole. Therefore, the through-hole hardly interferes with the light guided in the light guide sheet, and the evenness of the emission intensity is achieved. Because the through-hole has the cross shape, the light guide sheet is easily bent around the through-hole, the click feeling is further improved when the contact spring is pressed.

In the light guide sheet according to the third aspect of the present invention, a slit length of the cross-shaped through-hole may range from 0.1 mm to 4 mm. When the slit length of the through-hole is larger than 4 mm, the through-hole becomes conspicuous from the front face of the key illumination switch module, and the key illumination switch looks unattractive. Therefore, desirably the slit length of the through-hole is equal to or lower than 4 mm. Currently the forming accuracy of the slit-shaped through-hole is about 0.1 mm.

In the light guide sheet according to the third aspect of the present invention, the light guide sheet may be used to bond a dome-shaped contact spring to a rear surface of a cover sheet disposed on a rear surface side by an adhesive agent layer, and a diameter of a circle circumscribed to the through-hole is smaller than a diameter of the contact spring when viewed from a perpendicular direction. According to the measurement result, because the click rate is reduced when the diameter of the circle circumscribed to the through-hole is larger than the diameter of the contact spring, desirably the diameter of the circle circumscribed to the through-hole is smaller than the diameter of the contact spring.

In the light guide sheet according to the third aspect of the present invention, the light guide sheet may be used to bond a dome-shaped contact spring to a rear surface thereof by an adhesive agent layer, and a diameter of a circle circumscribed to the through-hole is smaller than a diameter of the contact spring when viewed from a perpendicular direction. According to the measurement result, because the click rate is reduced when the diameter of the circle circumscribed to the through-hole is larger than the diameter of the contact spring, desirably the diameter of the circle circumscribed to the through-hole is smaller than the diameter of the contact spring.

In the light guide sheet according to the third aspect of the present invention, a light shielding treatment may be performed to a sidewall surface in the through-hole. Accordingly, the stray light caused by the light reflected or refracted by the sidewall surface of the through-hole can be prevented from degrading the luminance evenness.

In the light guide sheet according to the third aspect of the present invention, a sheet thickness of a region corresponding to the through-hole in the light guide sheet may range from 0.1 times to 0.9 times a sheet thickness of a region located far away from the region corresponding to the through-hole. The portion located opposite the contact spring of the light guide sheet can further easily be bent by providing the thin-wall portion having the above-described thickness in the light guide sheet, so that the click feeling can further be improved.

### BRIEF DESCRIPTION OF THE DRAWINGS

FIG. 1 is a front view of a key illumination switch module according to a first embodiment of the present invention.

FIG. 2 is an exploded perspective view of the key illumination switch module of the first embodiment.

FIG. 3 is an enlarged sectional view illustrating a region including one contact spring of the key illumination switch module of the first embodiment.

FIG. 4 is a front view of a light guide sheet used in the first embodiment.

FIG. 5(a) is a schematic diagram for explaining action of the light guide sheet in the first embodiment, and FIG. 5(b) is an explanatory view of action of a light guide sheet of a comparative example.

FIG. 6(a) is a view illustrating a behavior of light passing through a slit in the first embodiment, and FIG. 6(b) is a view illustrating a behavior of light passing through a slit disclosed in Patent Document 1.

FIG. 7 is a view illustrating measurement result of a relationship (F-S curve) between a load applied to the contact spring and a displacement with respect to various samples.

FIG. 8 is a view illustrating the light guide sheets cut out from one light guide sheet.

FIG. 9 is an exploded perspective view of a mobile telephone in which the key illumination switch module of the first embodiment is used.

FIG. 10 is a front view illustrating the mobile telephone used in evaluation of look and luminance evenness.

FIG. 11 is an exploded perspective view illustrating a key illumination switch module according to a second embodiment of the present invention.

FIG. 12 is a sectional view of a key illumination switch in which a key top is stacked on a front face of the key illumination switch module of the second embodiment.

FIG. 13 is a front view of a light guide sheet according to a third embodiment of the present invention.

FIG. 14(a) is a perspective view illustrating a light guide sheet according to a fourth embodiment of the present invention, and FIG. 14(b) is an enlarged perspective view illustrating one slit.

FIG. 15(a) is a front view illustrating a light guide sheet according to a fifth embodiment of the present invention, and FIG. 15(b) is a front view illustrating another light guide sheet of the fourth embodiment.

FIG. 16(a) is a view illustrating a circular hole used in evaluation of a click rate, FIG. 16(b) is a view illustrating a cross-shaped slit used in the evaluation of the click rate, and FIG. 16(c) is a view illustrating a radial slit used in the evaluation of the click rate.

FIG. 17 is a view illustrating evaluation result of the click rate when a hole diameter of the circular hole illustrated in FIG. 16(a) is changed.

FIG. 18 is a view illustrating the evaluation result of the click rate when a length of the cross-shaped slit illustrated in FIG. 16(b) is changed.

FIG. 19 is a view illustrating the evaluation result of the click rate when a slit pitch of the radial slit illustrated in FIG. 16(c) is changed.

FIG. 20(a) is a sectional view illustrating a key illumination switch module in which a light guide sheet including a thin-wall portion is used, and FIG. 20(b) is a sectional view illustrating another key illumination switch module in which the light guide sheet including the thin-wall portion is used.

FIG. 21(a) is a perspective view illustrating a shape of a thin-wall portion including a cylindrical recess, and FIG. 21(b) is a sectional view of the thin-wall portion illustrated in FIG. 21(a).

FIG. 22(a) is a perspective view illustrating another shape of the thin-wall portion, and FIG. 22(b) is a sectional view of the thin-wall portion illustrated in FIG. 22(a).

FIG. 23(a) is a perspective view illustrating still another shape of the thin-wall portion, and FIG. 23(b) is a sectional view of the thin-wall portion illustrated in FIG. 23(a).

FIG. 24(a) is a perspective view illustrating still another shape of the thin-wall portion, and FIG. 24(b) is a sectional view of the thin-wall portion illustrated in FIG. 24(a).

FIG. 25 is a view illustrating a change in click rate by a position deviation amount D between a center of the slit and an apex of the contact spring.

FIG. 26 is a view illustrating the position deviation amount D between the center of the slit and the apex of the contact spring.

### DETAILED DESCRIPTION

Hereinafter, preferred embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

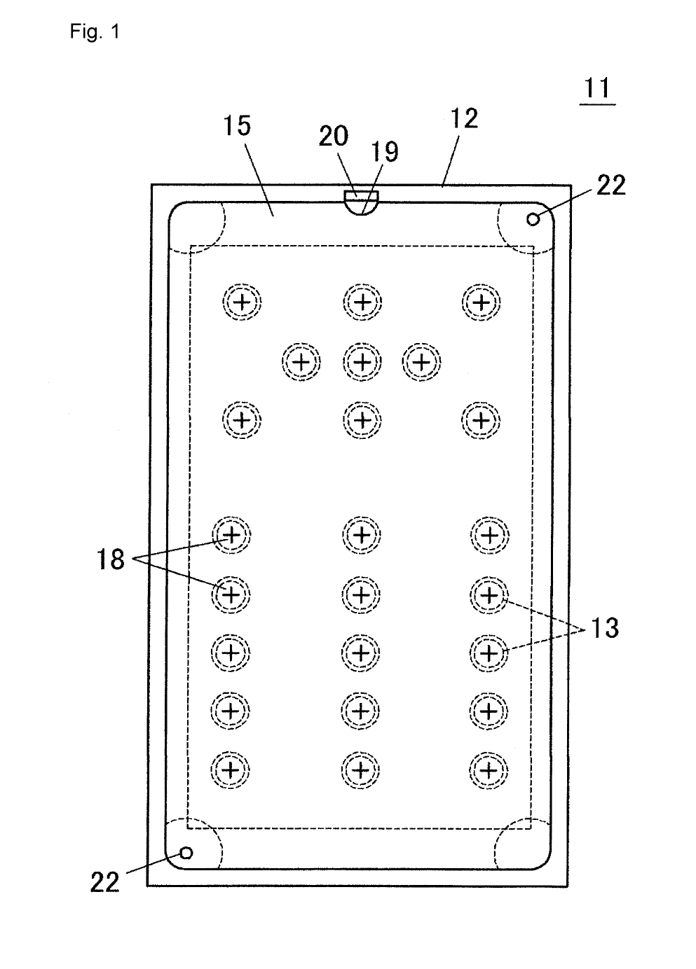

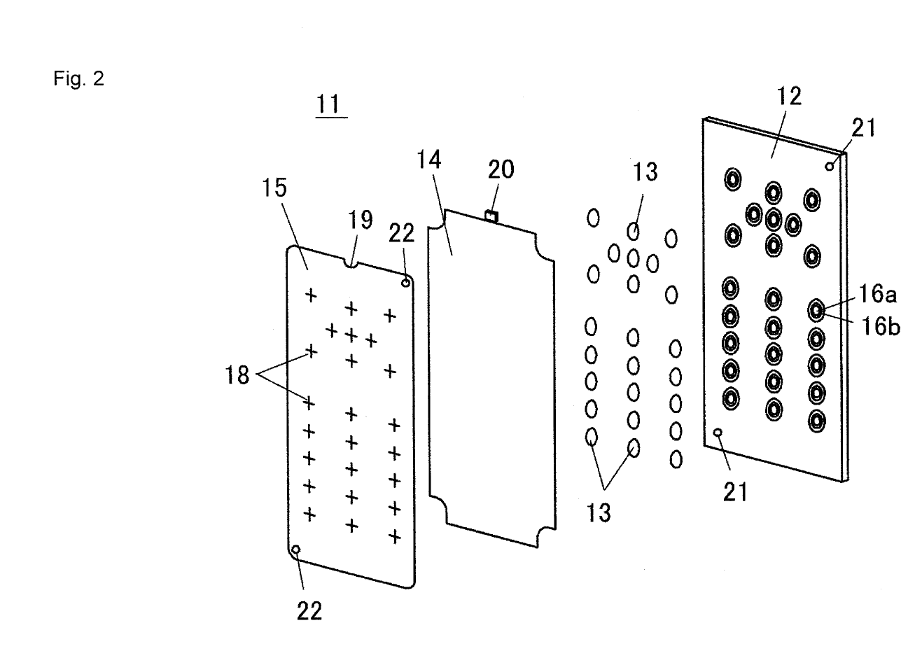

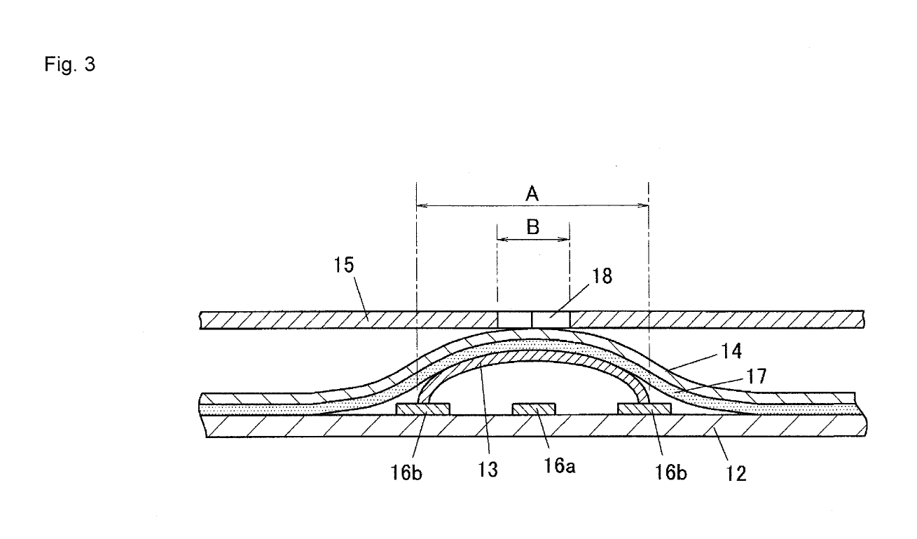

FIG. 1 is a front view of a key illumination switch module 11 according to a first embodiment of the present invention, FIG. 2 is an exploded perspective view of the key illumination switch module 11, and FIG. 3 is an enlarged sectional view illustrating a region including one contact spring of the key illumination switch module 11.

Referring to FIG. 2, the key illumination switch module 11 includes a printed wiring board 12 (board) that is formed by a flexible printed board, a contact spring 13, a cover sheet 14, and a light guide sheet 15. Plural circular first contact portions 16a made of a conductive material are arrayed in a surface of the printed wiring board 12, and each of the first contact portion 16a includes a ring-shaped second contact portion 16b that surrounds the first contact portion 16a. An insulating gap is formed between the first contact portion 16a and the second contact portion 16b. The printed wiring board 12 includes a positioning hole 21 in a corner portion thereof.

The contact spring 13 is formed into a projected dome shape by a metallic material having both a conductivity and elasticity, in particular a stainless steel material, and a rear surface side of the contact spring 13 is recessed in a cup shape. A diameter of the contact spring 13 is larger than an inner diameter of the second contact portion 16b and smaller than an outer diameter of the second contact portion 16b.

The cover sheet 14 has a function of retaining the contact spring 13 and functions as a reflecting sheet of the light guide sheet 15. Accordingly, the cover sheet 14 is formed by a thin, soft, high-reflectance resin sheet, in particular a white resin sheet. An even-thickness adhesive layer 17 (illustrated in FIG. 3) is provided in a rear surface of the cover sheet 14 by an adhesive agent.

The light guide sheet 15 is molded into a sheet shape by a high-refractive-index transparent resin material, and the light guide sheet 15 has flexibility. Examples of a material for the light guide sheet 15 include a polycarbonate resin, an acrylic resin, and PET, and Si can also be used as the need arises. A light incident portion 19 that is notched into an arc shape is provided in one of end portions of the light guide sheet 15, and a light source 20 such as an LED is disposed opposite the light incident portion 19. A positioning hole 22 is provided in a corner portion of the light guide sheet 15, and the positioning hole 21 and the positioning hole 22 make a pair.

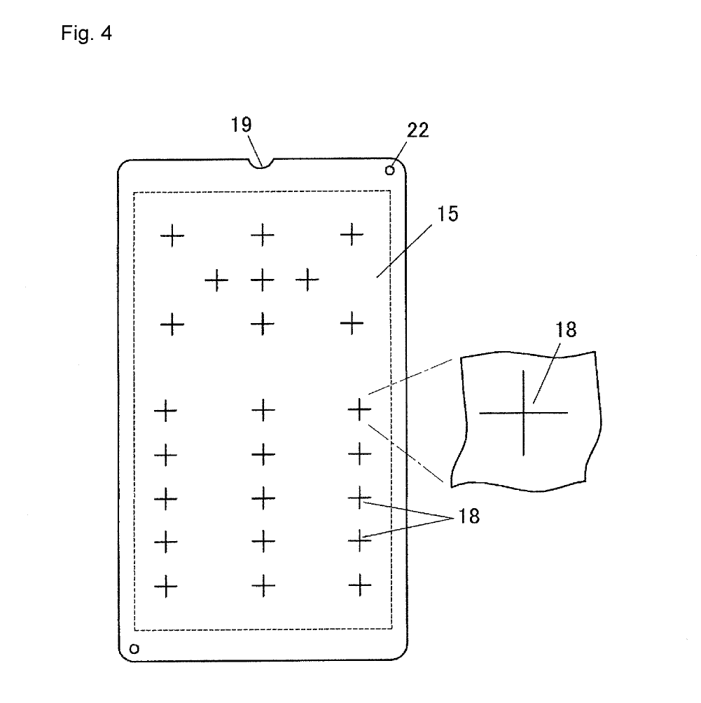

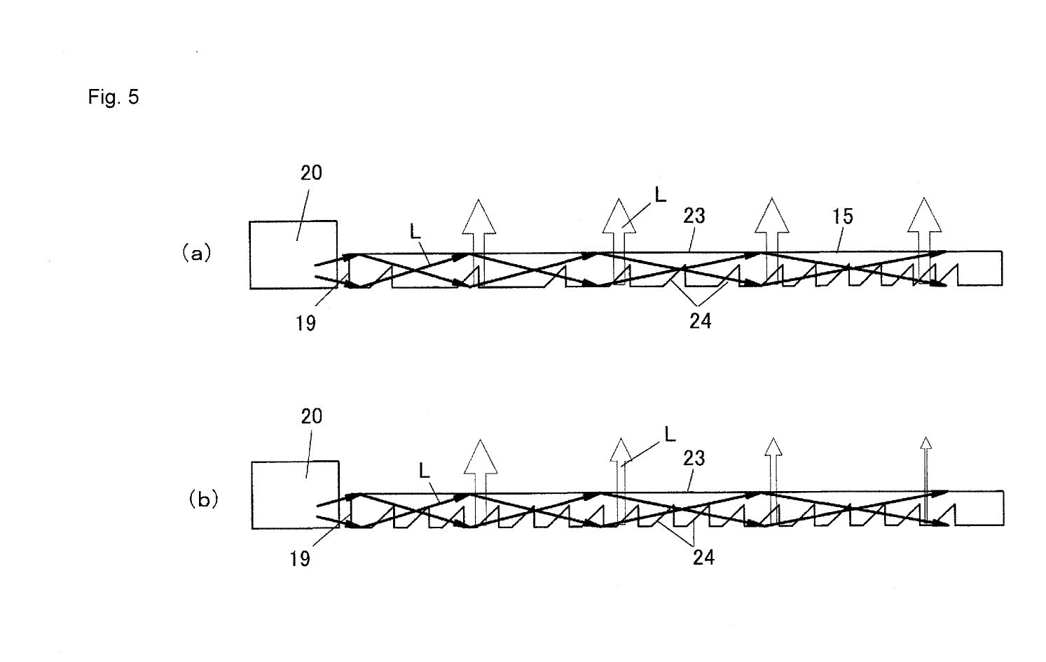

FIG. 4 is a front view of the light guide sheet 15. A micro diffusion pattern of tens micrometers to hundreds micrometers is formed in a pattern area expressed by a broken line in the surface (light outgoing surface 23) of the light guide sheet 15, and many micro light deflection patterns 24 (see FIG. 5) are formed in the rear surface of the light guide sheet 15. Through-holes made into cross shapes by slit processing, that is, slits 18 are provided in the light guide sheet 15 while disposed at the same positions as first contact portions 16a. In the slit 18, linear slits intersect each other into the cross shape. The slit 18 penetrates from the surface of the light guide sheet 15 to the rear surface. Because the slit 18 is formed by a cutout using a thin cutter or the like, a two-dimensionally-spread hole is not opened even if the slit 18 is the through-hole.

FIGS. 1 and 3 illustrate the key illumination switch module 11 in an assembled state. Each of the contact springs 13 is fixed to a predetermined position in the rear surface of the cover sheet 14 by bonding an apex portion to the adhesive layer 17. The contact spring 13 is placed on the second contact portion 16b such that the first contact portion 16a is covered therewith, and the adhesive layer 17 is bonded to the surface of the printed wiring board 12, whereby the contact spring 13 is positioned and fixed to the surface of the printed wiring board 12 while the cover sheet 14 and the printed wiring board 12 are integrated with each other. The light guide sheet 15 is stacked on the cover sheet 14 such that the positioning hole 22 is aligned with the positioning hole 21 of the printed wiring board 12, and the light guide sheet 15 is fixed to the cover sheet 14 by a double-sided adhesive tape or a paste. In the light guide sheet 15 positioned in the above-described manner, the center of each of the slits 18 is aligned with the apex (center) position of the contact spring 13. The light source 20 is mounted on the printed wiring board 12 while located opposite the light incident portion 19.

In the key illumination switch module 11, because the light source 20 is mounted opposite the light incident portion 19 of the light guide sheet 15 as illustrated in FIG. 5(a), light L emitted from the light source 20 is incident to the light incident portion 19, and the light incident to the light guide sheet 15 is spread into a plane by the arc-shaped light incident portion 19. The light incident to the light guide sheet 15 is guided while reflected between the surface of the light guide sheet 15 and the rear surface. Many micro light deflection patterns 24 formed into a triangular prism shape, a conical shape, a hemispherical shape, or the like are provided in a surface (surface located opposite the cover sheet 14) on the opposite side of the light outgoing surface 23 of the light guide sheet 15. When the light L guided through the light guide sheet 15 is incident to the light deflection pattern 24, the light L that is totally reflected by the light deflection pattern 24 is output to the outside from a light outgoing surface 23. Because micro diffusion patterns are formed in the light outgoing surface 23, the light output from the light outgoing surface 23 is diffused by the diffusion patterns, and a luminance distribution is homogenized in the surface of the light guide sheet 15. Therefore, when the keys are arrayed while located opposite the light outgoing surface 23 of the light guide sheet 15, the keys can be illuminated from the rear surface with the light output from the light guide sheet 15.

Because the cover sheet 14 located opposite the rear surface of the light guide sheet 15 acts as the high-reflectance reflecting sheet, the light that leaks from the rear surface of the light guide sheet 15 is reflected by the cover sheet 14 and incident to the light guide sheet 15 again. Therefore, a loss caused by the light that leaks from the rear surface of the light guide sheet 15 can be reduced to enhance light use efficiency. Because the cover sheet 14 acts as the reflecting sheet, it is not necessary to separately provide the reflecting sheet, and therefore cost reduction can be achieved.

FIG. 5(b) illustrates a comparative example of the light guide sheet 15, and the light deflection patterns 24 have constant distribution density irrespective of a distance from the light source 20. When the light deflection patterns 24 have the distribution of FIG. 5(b), the light is output from the light outgoing surface 23 along the way, a small light quantity reaches the light deflection pattern 24 located far away from the light source 20, and therefore a region located far away from the light source 20 becomes dark.

In order to solve the trouble, as illustrated in FIG. 5(a), desirably the distribution density of the light deflection patterns 24 is increased with increasing distance from the light source 20. Although the light quantity reaching the light deflection pattern 24 is decreased with increasing distance from the light source 20, a possibility that the light is reflected by the light deflection pattern 24 becomes high because the distribution density of the light deflection patterns 24 is increased. Therefore, the light quantity output from the light outgoing surface 23 is homogenized to homogenize the luminance distribution.

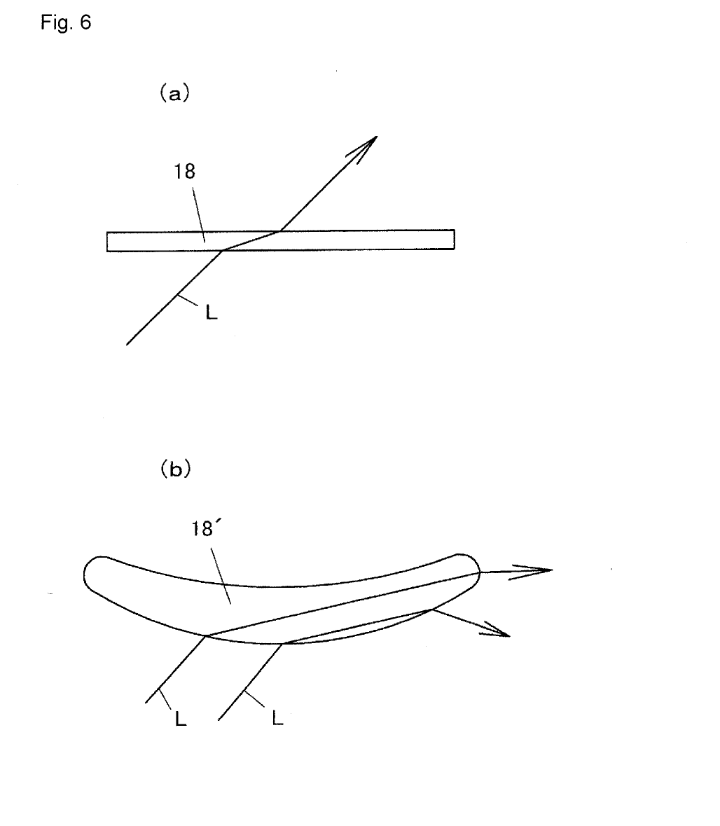

The slit 18 is provided in the light guide sheet 15 in order to improve the click feeling. When the slit 18 is formed by a linear slit, the slit 18 hardly interferes with the evenness of the luminance distribution. FIGS. 6(a) and 6(b) explain the reason. When the slit is formed by a curved slit 18′ like Patent Document 1, the quantity of light largely warped is increased in the light L passing through the slit 18′ as illustrated in FIG. 6(b), and the slit 18′ interferes easily with the light L. When the slits 18′ are provided such that the contact spring 13 is sandwiched therebetween, the light hardly reaches the region of the contact spring 13, and the region of the contact spring 13 becomes dark. On the other hand, when the linear slit is used, because the light L passes through the slit 18 without changing the direction of the light Las illustrated in FIG. 6(a), the slit 18 hardly interferes with the light. Additionally, because the slit 18 is provided in the apex portion of the contact spring 13, the region that is surrounded by the slit 18 is not generated, and the unevenness of the luminance distribution is hardly generated.

The click feeling of the key illumination switch module 11 of the first embodiment will be described below. In the key illumination switch module 11 having the structure illustrated in FIG. 3, when a portion corresponding to the contact spring 13 is pressed from above the light guide sheet 15, the contact spring 13 performs a click operation to come into contact with the first contact portion 16a, and electric conduction between the first contact portion 16a and the second contact portion 16b is established with the contact spring 13 interposed therebetween to turn on the switch (closed state). At this point, because the slit 18 is provided in the light guide sheet 15 such that the center of the slit 18 is aligned with the apex of the contact spring 13, the light guide sheet 15 is easily bent in the portion corresponding to the contact spring 13 by the slit 18, and a reaction force is reduced when the contact spring 13 is pressed. That is, because a return load is increased when the contact spring 13 is pressed, the click feeling (click rate) becomes good.

Result that an effect of the first embodiment is confirmed by an actual sample will be described below.

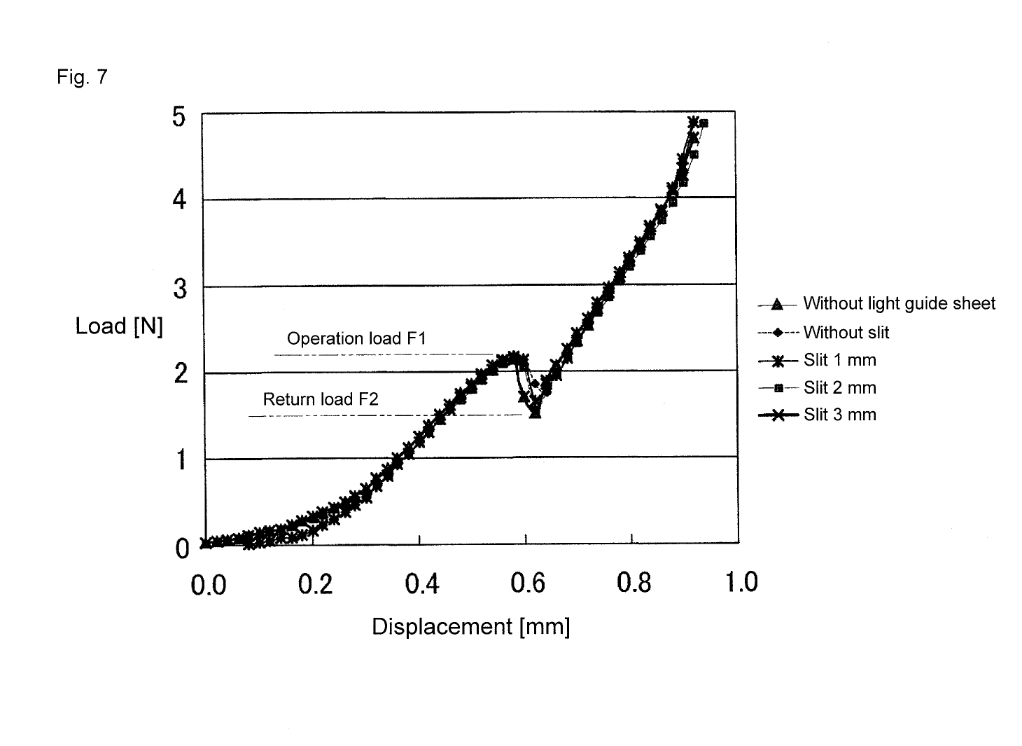

FIG. 7 is a view illustrating measurement result of a relationship (F-S curve) between the load applied to the contact spring and a displacement with respect to various samples. The samples used includes (1) a key illumination switch module without a light guide sheet, (2) a key illumination switch module 11 in which a light guide sheet without a slit was used, (3) a key illumination switch module 11 in which a light guide sheet having a cross-shaped slit whose slit length B was 1 mm was used, (4) a key illumination switch module 11 in which a light guide sheet having a cross-shaped slit whose slit length B was 2 mm was used, and (5) a key illumination switch module 11 in which a light guide sheet having a cross-shaped slit whose slit length B was 3 mm was used. The click rate of each sample was computed from the measurement result. The contact spring 13 had a diameter A of 4 mm.

The click rate was computed as follows. A gradually-increasing load is applied to a point immediately above the contact spring in each sample, and a displacement of the apex of the contact spring is measured at the time (FIG. 7). The contact spring is elastically deformed when the load is gradually increased, and the click operation is performed when the load reaches a certain value, thereby measuring a load (operation load) F1 at the beginning of the click operation. When the click operation is ended to gradually decrease the load from the state in which the contact spring 13 is elastically deformed, the contact spring is elastically returned at a certain load, thereby measuring a load (return load) F2 in the elastic return. The click rate is computed from the following equation using the measured operation load F1 and return load F2:

click rate [%]=100×(F1−F2)/F1

With increasing value of the click rate, the feeling becomes better in the click.

As can be seen from FIG. 7, a dynamic load is kept constant in each sample. On the other hand, the return load depends on the sample, and therefore the value of the click rate depends on the sample. As a result of the computation, the click rate was 28.6% in the sample (1) without the light guide sheet. On the other hand, click rate was 21.3% in the sample (2) in which the light guide sheet without the slit was used, and it is found that the click feeling is largely lost when the light guide sheet is inserted. This is because the reaction force of the light guide sheet is applied to increase the return load when the light guide sheet is inserted.

In the samples (1) to (3) in which the light guide sheet having the slit whose length ranges from 1 to 3 mm was used, the click rates were 24.6%, 27.1%, and 27.5%, respectively, and it is found that the click feeling is improved by providing the slit in the light guide sheet. This is because the reaction force from the light guide sheet can be decreased by forming the slit in the light guide sheet. The click rate can be brought close to the value, in which the light guide sheet does not exist, by providing the slit.

Although the click rate is enhanced with increasing slit length, a look during illumination is improved because the slit hardly interferes with the light when the slit length is decreased. Even if the click rate is reduced by 3%, the feeling is comparable to the absence of the light guide sheet when the contact spring is pressed to perform the click. Therefore, in one or more embodiments of the invention, the slit length is not lower than 2 mm.

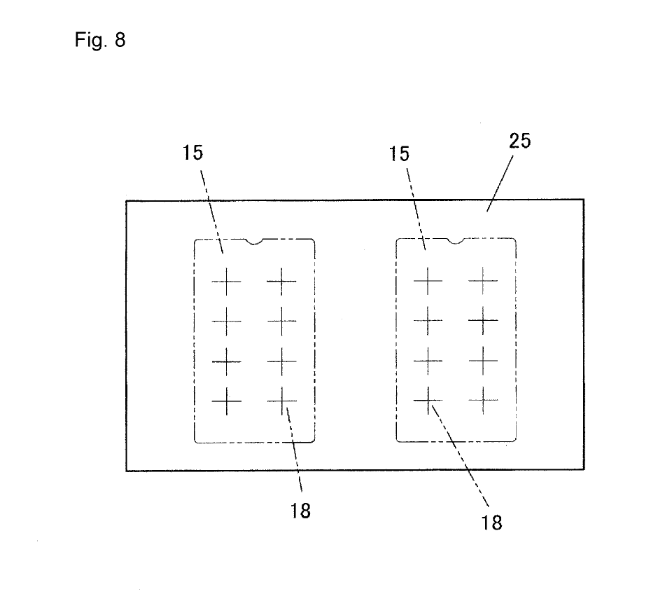

Usually the plural light guide sheets 15 are obtained once by pressing or cutting a large-size light guide sheet 25 into an outer shape of the light guide sheet 15. When the light guide sheet 25 is pressed, a blade is provided to cut the slits 18 in a press die used to punch through the outer shape of the light guide sheet 15, and the slits 18 can be cut as the same time as the outer shape of the light guide sheet 15 is punched through from the light guide sheet 25 as illustrated in FIG. 8. In the above-described method, the light guide sheet 15 including the slits 18 is obtained without increasing the number of processes, so that the light guide sheet 15 can be obtained at cost equal to that of the conventional method.

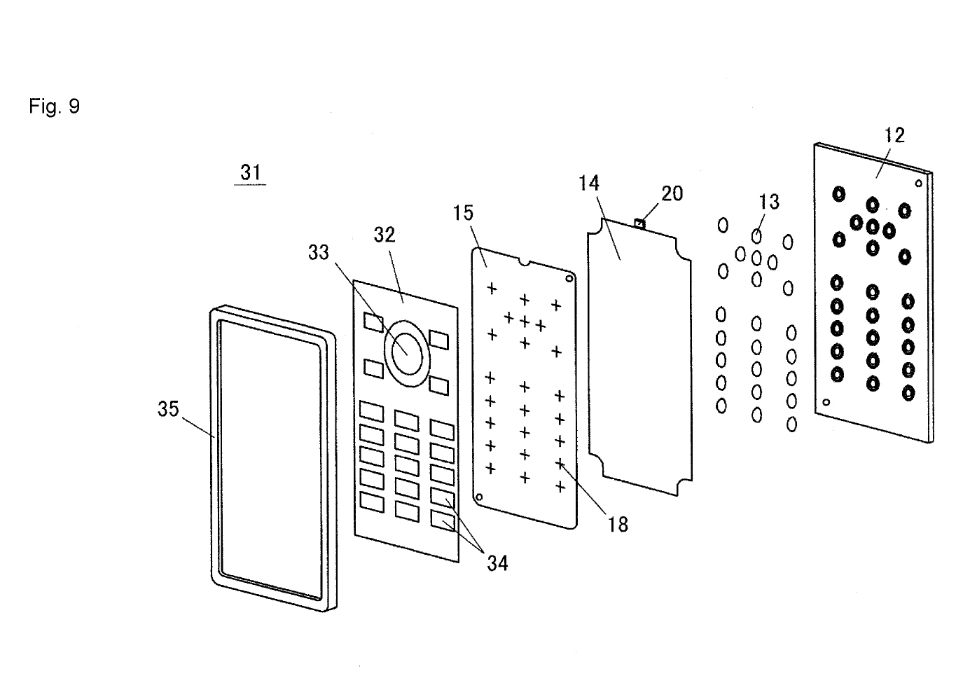

FIG. 9 illustrates a manipulation portion of a mobile telephone 31 in which a key top 32 is stacked on a front face of the key illumination switch module 11 while surroundings are covered with a frame 35. The key top 32 includes a toggle switch 33 and keys 34 that are press the contact springs 13 from above the light guide sheet 15.

TABLE 1 illustrates evaluation results of the look (appearance) and the luminance evenness in each key array surface using (1) a mobile telephone without the light guide sheet, (2) a mobile telephone having the cross-shaped slit whose slit length B was 1 mm was used, (3) a mobile telephone having the cross-shaped slit whose slit length B was 2 mm was used, (4) a mobile telephone having the cross-shaped slit whose slit length B was 3 mm was used, and (5) a mobile telephone having the cross-shaped slit whose slit length B was 4 mm was used.

TABLE 1

| | | Cross-shaped | Cross-shaped | Cross-shaped | Cross-shaped |
|---|---|---|---|---|---|
| | Without | slit | slit | slit | slit |
| | slit | (Length of 1 mm) | (Length of 2 mm) | (Length of 3 mm) | (Length of 4 mm) |
| Look | ◯ | ◯ | ◯ | ◯ | ◯ |
| (Appearance) | | | | | |
| Luminance | 65% | 65% | 60% | 45% | 30% |
| evenness | | | | | |

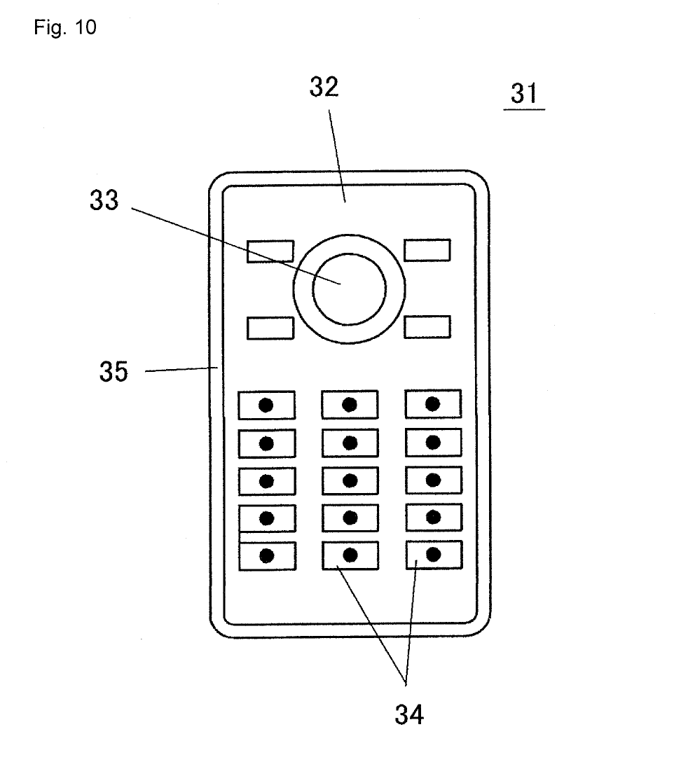

At this point, the luminance evenness was measured as follows. That is, luminance was measured in the center of each key 34 expressed by a black circle in FIG. 10, and the luminance evenness defined by luminance evenness=100×luminance minimum value/luminance maximum value was computed. For the look, the appearance is visually evaluated, the key array surface that is evenly shiny is expressed by a mark “◯”, and the key array surface that is unevenly shiny is expressed by a mark “x”.

As can be seen from the evaluation result of TABLE 1, the look and the luminance evenness that are comparable to the absence of the slit are obtained when the cross-shaped slit having the slit length or 2 mm or less. Therefore, in order to improve the look and the luminance evenness, desirably the slit length B is set to 2 mm or less. However, the luminance evenness of about 45% is obtained even if the slit length is set to 3 mm, and the luminance evenness of about 45% is equal to or more than the luminance evenness of the key portion of the currently available mobile telephone. Therefore, the slit length may be set lower than 4 mm. Because the contact spring 13 has the diameter of 4 mm, this means that the length of the slit 18 is lower than the diameter of the contact spring 13.

As described above, in order to improve the click feeling, desirably the slit length is set to 2 mm or more. The appearance of the illuminated key portion becomes good when the slit length is 2 mm or more. Therefore, in consideration of the both, the slit length is optimally set to 2 mm in order to establish a balance between the click feeling and the look during the illumination.

### Second Embodiment

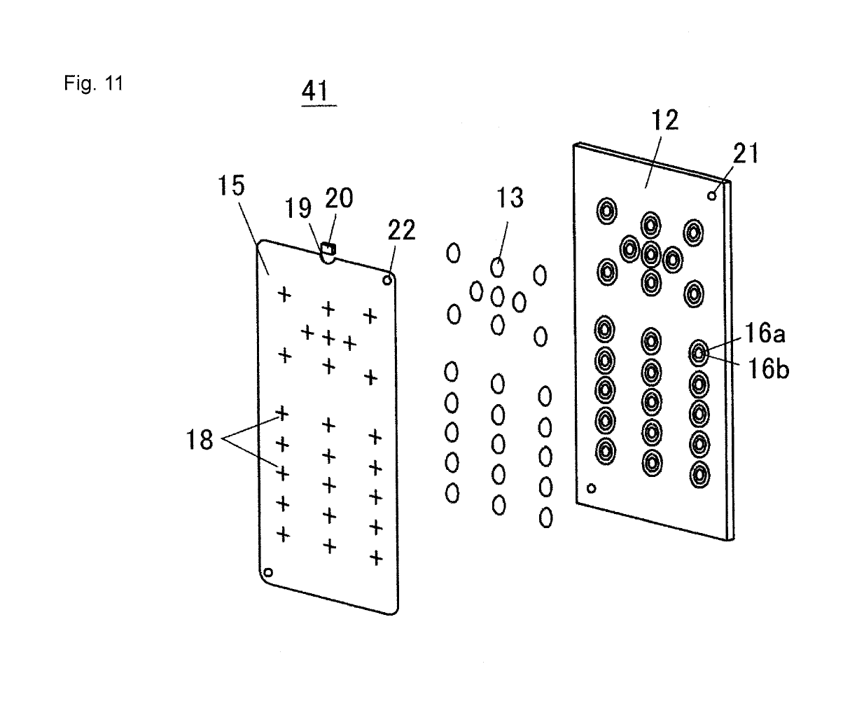

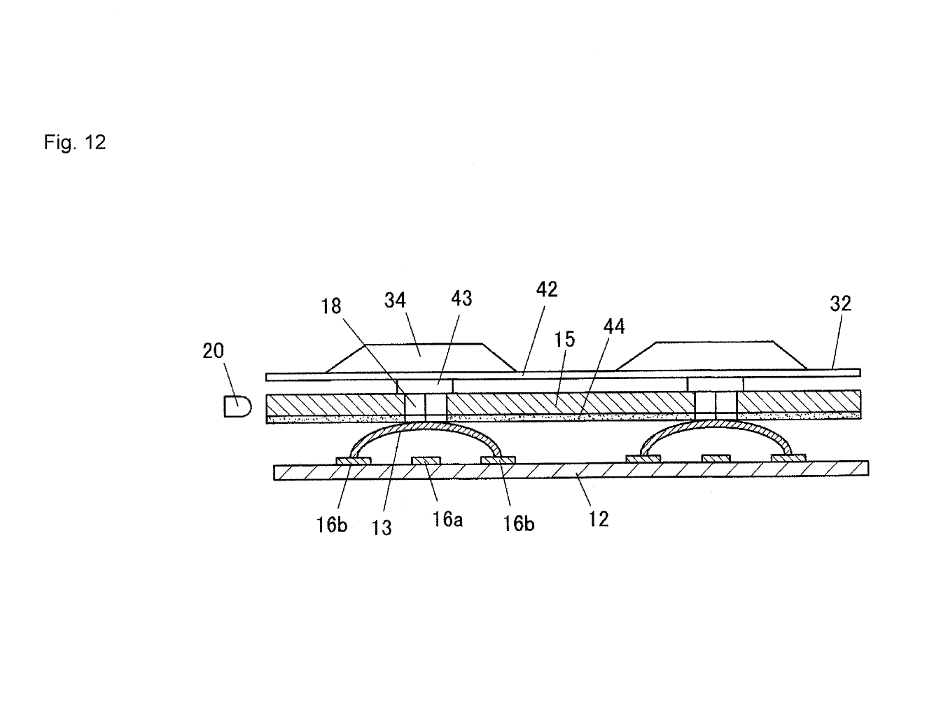

FIG. 11 is an exploded perspective view illustrating a key illumination switch module 41 according to a second embodiment of the present invention, and FIG. 12 is a sectional view of a key illumination switch in which the key top 32 is stacked on the front face of the key illumination switch module 41 of the second embodiment. In the second embodiment, the cover sheet is not included, but an adhesive layer 44 is provided in the rear surface of the light guide sheet 15 including the slits 18. The apex portion of the contact spring 13 is bonded to the rear surface of the light guide sheet 15 by the adhesive layer 44 while aligned with the position of the slit 18, thereby fixing the contact spring 13.

In the key top 32, the key 34 is provided in the surface of a soft key sheet 42, and a pusher 43 is provided in the rear surface of the key sheet 42 according to the rear surface of the key sheet 42. The pusher 43 is located opposite the apex portion of the contact spring 13 and the slit 18 to abut on the surface of the light guide sheet 15.

According to the second embodiment, the key illumination switch module 41 can be thinned by removing the cover sheet, and the cost can also be reduced. The click feeling is further improved because the cover sheet is not interposed between the key 34 and the contact spring 13. The cross-shaped slit 18 is provided in the light guide sheet 15 at the position corresponding to the apex of the contact spring 13, so that the click feeling can be improved without losing the appearance of the illumination portion similarly to the first embodiment.

### Third Embodiment

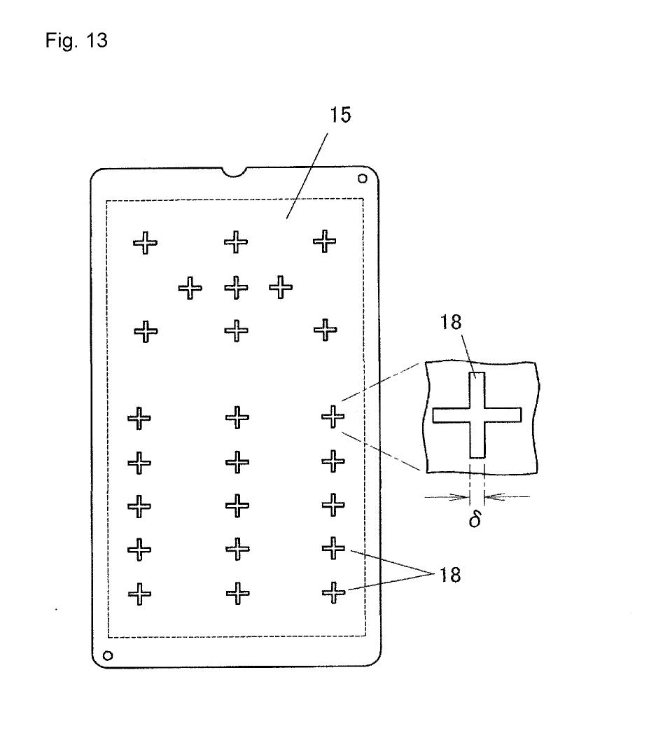

FIG. 13 is a front view of a light guide sheet according to a third embodiment of the present invention, and FIG. 13 is a front view of a light guide sheet 15. In the third embodiment, the slit 18 is formed by not simply notching the light guide sheet 15, but cutting out the light guide sheet 15 with a certain width. Accordingly, a gap is formed between sidewall surfaces located opposite each other in the slit 18.

In the third embodiment, the generation of the wear scrap is prevented when the key is pressed. In the notch that is simply formed by a thin blade, the sidewall surfaces of the slit 18 scrape with each other when the key is pressed to bend the light guide sheet 15, and there is a risk of generating the wear scrap from the slit 18 by repeatedly pressing the key. When the wear scrap invades between the contact spring 13 and the contact portions 16a and 16b, the electric is interfered with between the conduction contact spring 13 and the contact portions 16a and 16b to possibly generate the conduction defect of the switch.

On the other hand, in the third embodiment, because the sidewall surfaces of the slit 18 do not scrape with each other, the generation of the wear scrap can be suppressed to prevent the conduction defect between the contacts. A size δ of the gap between the sidewall surfaces in the slit 18 suitably ranges from about 0.1 mm to about 0.5 mm in consideration of the look during the illumination, the click performance, and the high-volume production method. The pressing with the die or laser forming can be cited as an example of the high-volume production method for the slit 18 including the gap.

### Fourth Embodiment

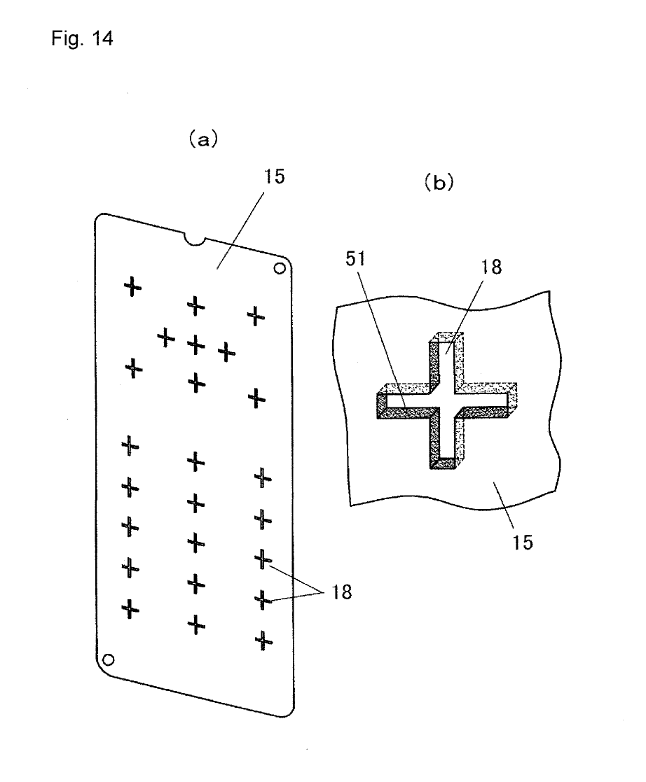

FIG. 14(a) is a perspective view illustrating a light guide sheet 15 according to a fourth embodiment of the present invention, and FIG. 14(b) is an enlarged perspective view illustrating one slit 18. In the fourth embodiment, a light shielding layer 51 is formed in the whole sidewall surface of the slit 18. The light shielding layer 51 may be formed by high-absorptance paint or dye such as black paint and black ink. For example, when the black ink is applied onto the slit 18 with a dispenser after the slit 18 is provided in the light guide sheet 15, the black ink penetrates in the slit 18 to spread into the whole slit 18 by capillary action, thereby forming the light shielding layer 51. At this point, the slit 18 may have the gap or no gap.

When the light shielding layer 51 is provided in the sidewall surface of the slit 18, the stray light that is caused by the light reflected or refracted by the slit 18 can be prevented from degrading the luminance evenness. Even if the light is not transmitted through the slit 18, because the slit 18 is located at the apex of the slit 18, there is no risk of generating the dark portion unlike Patent Document 1 in which the slits are provided opposite each other in the outer peripheral portion of the contact spring 13 so as to sandwich the contact spring 13 therebetween.

### Fifth Embodiment

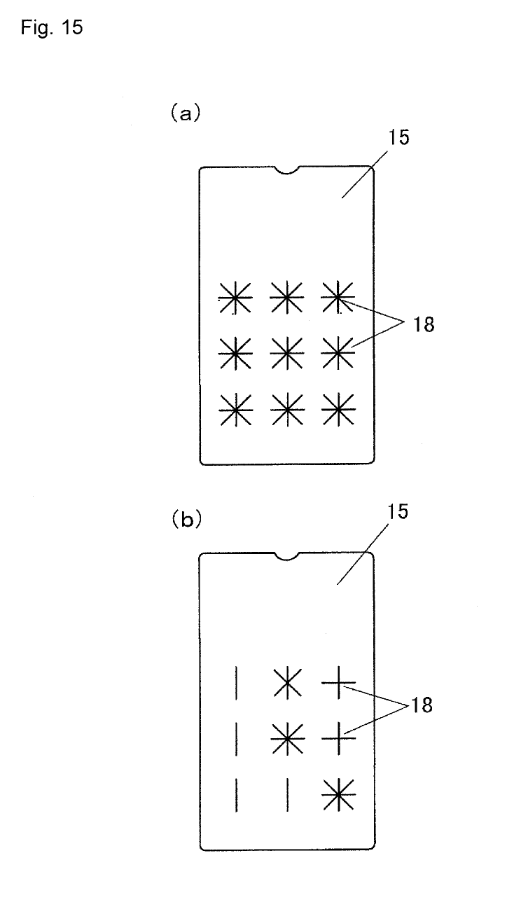

The cross-shaped slit 18 is described in the first to fourth embodiments. The slit 18 may be formed by a combination of linear slits. For example, radial slits 18 illustrated in FIG. 15(a) may be used. Linear slits 18 illustrated in FIG. 15(b) may be used, and the cross-shaped slits 18, the linear slit 18, and the radial slit 18 may be mixed. In particular, when the shape of the slit 18 is changed according to the position at which the slit 18 is provided, a variation of the click feeling of the key can be reduced by the shape of the slit 18.

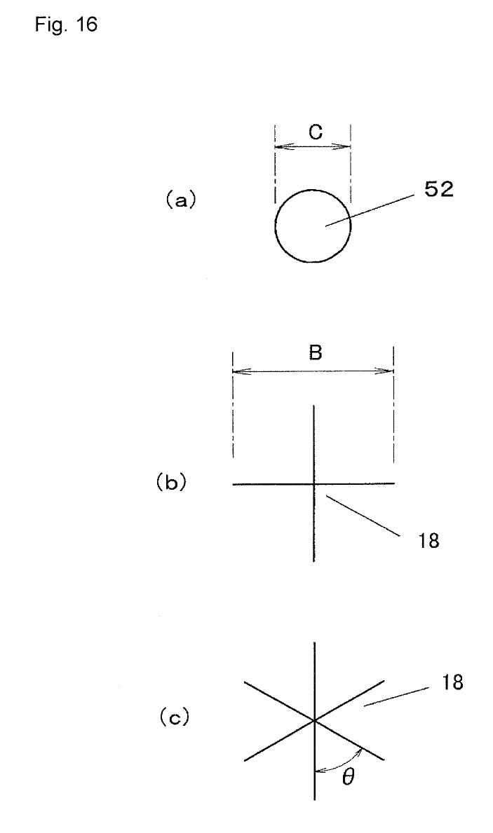

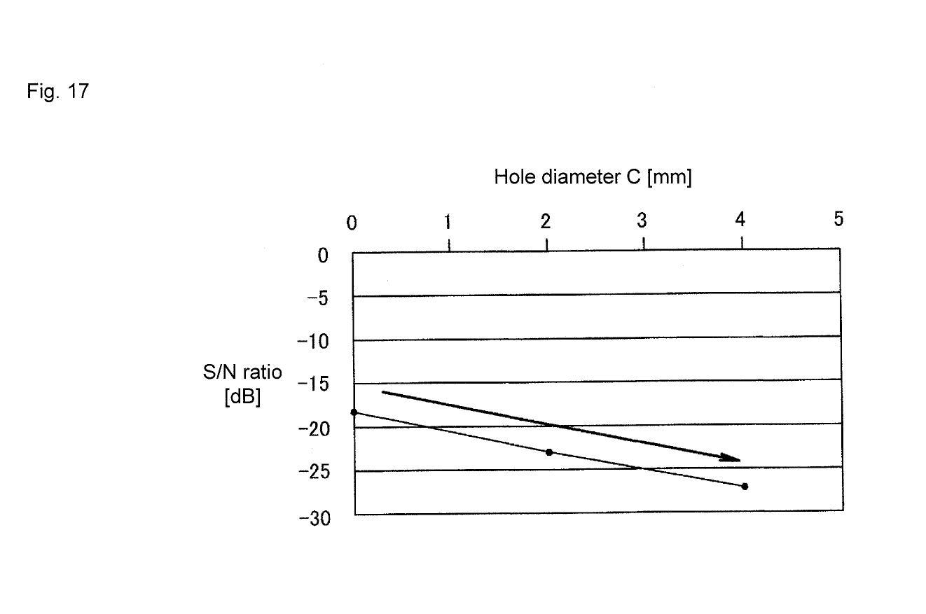

Because various shapes of the slit 18 can be used, the good shape of the slit 18 was studied. A diameter C of a circular hole 52 illustrated in FIG. 16(a) was changed to 0 mm (that is, the circular hole is absent), 2 mm, and 4 mm to determine an S/N ratio [dB]. The S/N ratio has a correlation with the click rate, and the click rate is increased with decreasing absolute value of the S/N ratio. FIG. 17 illustrates the measurement result, and the click rate tends to be decreased with increasing diameter of the circular hole 52. The reason is attributed to the fact that a spacer effect of the light guide sheet 15 is obtained by decreasing the diameter of the circular hole 52 and the pusher 43 of the key top 32 does not press the contact spring 13. Therefore, because the hole diameter C of the circular hole 52 is desirably made as small as possible, the circular hole 52 needs not to be provided while overlapping the slit 18.

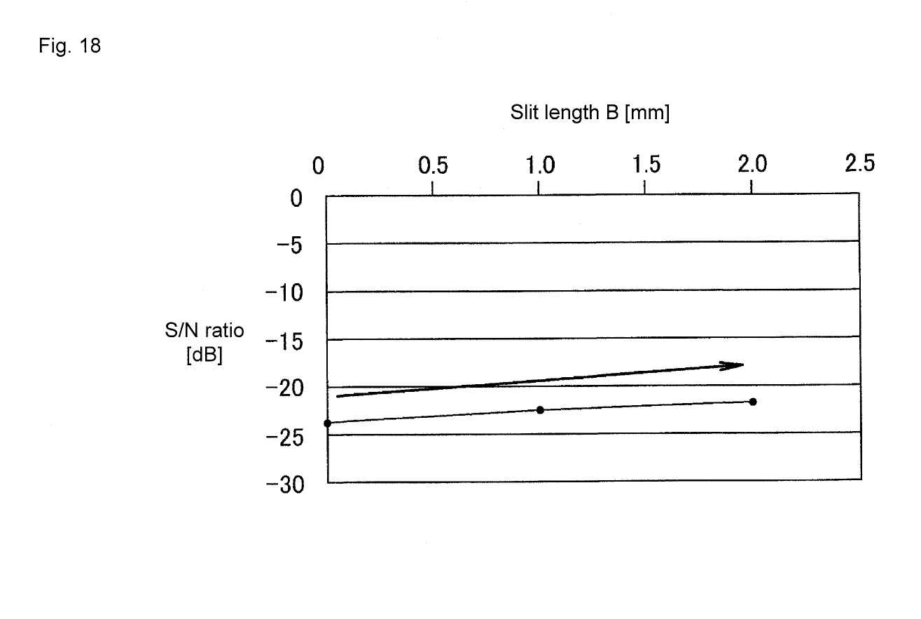

A slit length B of the cross-shaped slit 18 illustrated in FIG. 16(b) was changed to 0 mm (that is, the slit is absent), 1 mm, and 2 mm to determine the S/N ratio [dB]. FIG. 18 illustrates the measurement result, and the click rate tends to be increased with increasing length B of the slit 18. The reason is attributed to the fact that, with decreasing slit length B, the reaction force of the light guide sheet 15 is reduced to be able to suppress the return load. Therefore, desirably the slit length B of the slit 18 is lengthened in order to improve the click rate.

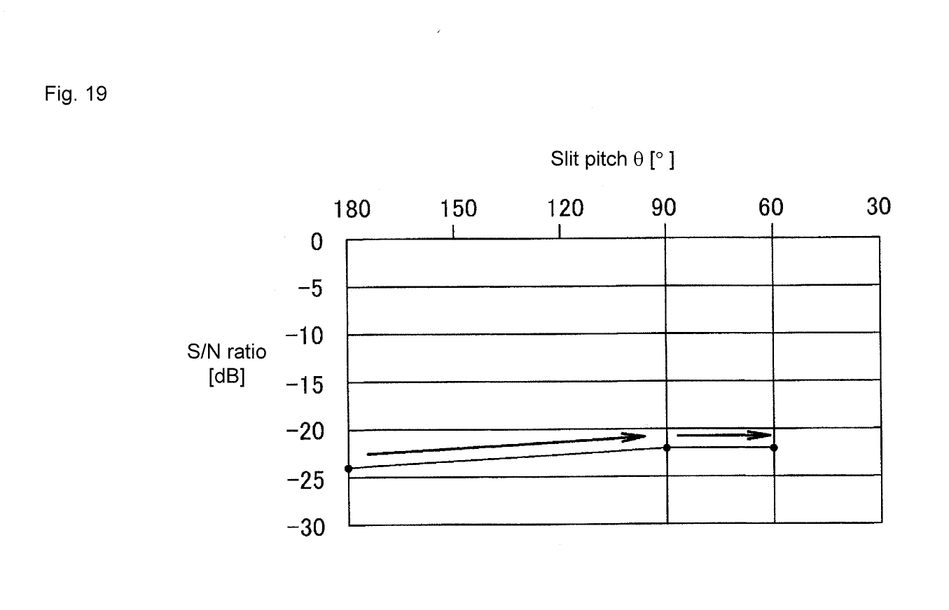

A cut pitch θ (an angle between the slits) of the radial slit 18 illustrated in FIG. 16(c) was changed to 180° (that is, the linear slit), 90° (that is, the cross-shaped slit), and 60° (that is, the hexagonally radial slit) to determine the S/N ratio [dB]. FIG. 19 illustrates the measurement result. As illustrated in FIG. 19, although the cut pitch θ of 180° is higher than the cut pitch θ of 90° in the click rate, the click rate is saturated when the cut pitch θ becomes 90°, and the click rate at the cut pitch θ of 60° does not exceed the click rate at the cut pitch θ of 90°. The click rate is substantially kept constant when the cut pitch θ is equal to or lower than 90°. Because he die for forming the slit 18 becomes complicated when the cut pitch θ is decreased, the cut pitch θ is optimally set to 90°, that is, the cross-shaped slit 18 is optimally used.

### Sixth Embodiment

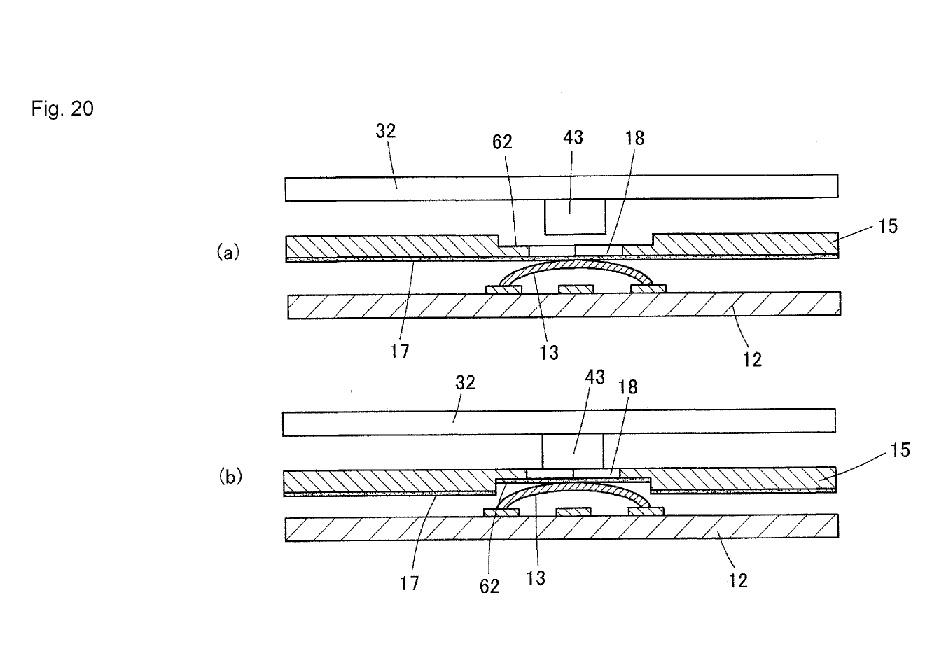

In the light guide sheet 15, a portion corresponding to contact spring 13 may partially be thinned. For example, in a key illumination switch 61 illustrated in FIG. 20(a), the surface side of the light guide sheet 15 is partially trimmed to form a thin-wall portion 62. In a key illumination switch 63 illustrated in FIG. 20(b), the rear surface side of the light guide sheet 15 is partially trimmed to form the thin-wall portion 62. A thickness of the thin-wall portion 62 is set to about 10% to about 90% of a thickness of a portion except the thin-wall portion 62. According to the structure of FIGS. 20(a) and 20(b), the portion of the light guide sheet 15, which is located opposite the contact spring 13, is easily bent to decrease the reaction force, so that the performance comparable to t the click rate in the absence of the light guide sheet can be realized (the decrease in click rate becomes 0.5% or less).

When the thickness of the whole of the light guide sheet 15 is decreased, the light quantity input from the light source 20 into the light guide sheet 15 is decreased, or an attenuation amount of the light guided in the light guide sheet 15 is increased, thereby hardly securing the luminance and the luminance evenness. However, the troubles can be avoided by partially decreasing the thickness of the light guide sheet 15.

When the thickness of the whole of the light guide sheet 15 is decreased, because the light guide sheet 15 is easily bent, handling becomes difficult in assembling the key illumination switch module, and therefore an expensive handling device is required to possibly increase the cost. However, the trouble can be avoided by partially decreasing the thickness of the light guide sheet 15.

Examples of the method for partially thinning the light guide sheet 15 include a method for forming the thin-wall portion 62 by pressing after the light guide sheet 15 is formed and a method for forming the thin-wall portion 62 by transferring a projection portion of the die in forming the light guide sheet 15.

In consideration of a deviation of the thin-wall portion 62 and the diameter of the pusher 43 of the key top 32, desirably the diameter of the thin-wall portion 62 is larger than the diameter A (4 mm or more) of the contact spring 13.

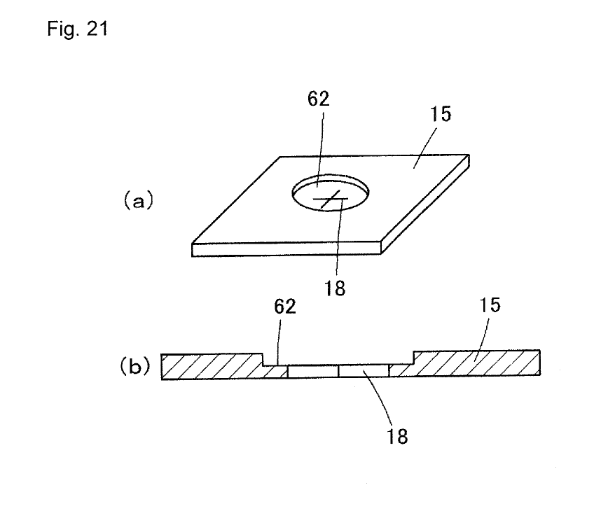

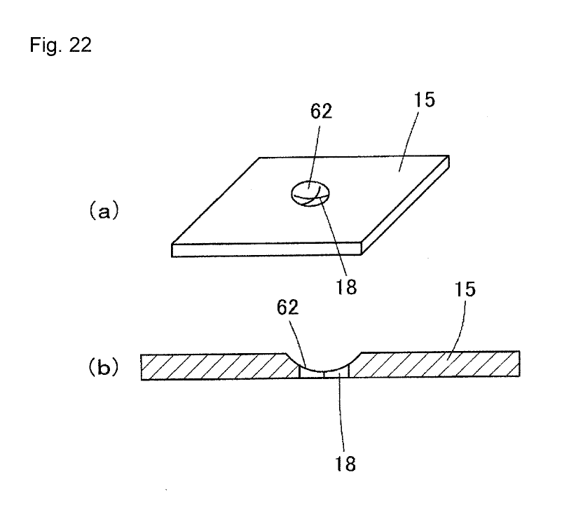

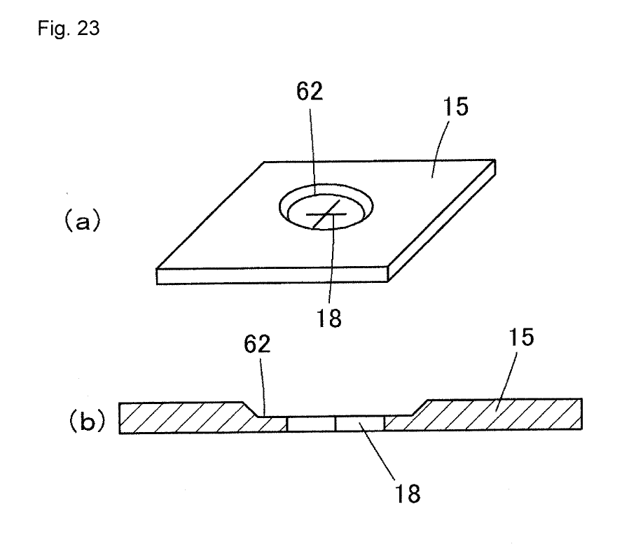

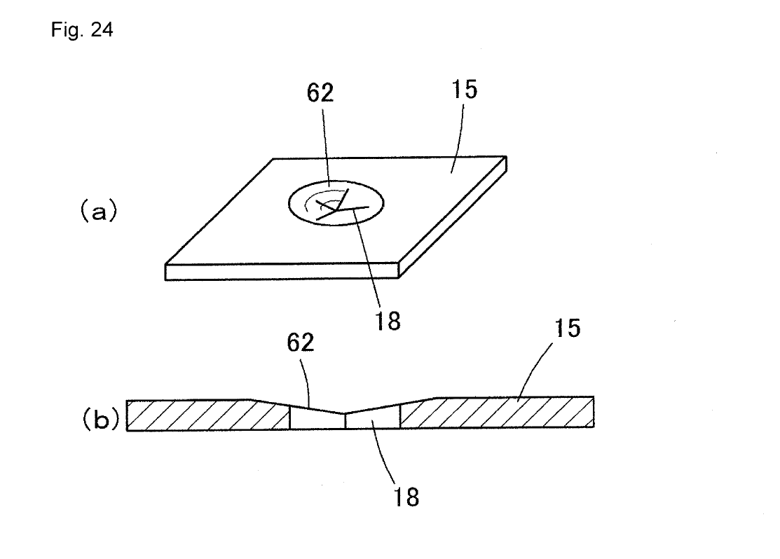

The shape of the thin-wall portion 62 is not limited to the simple recess shape, but various shapes may be used as illustrated in FIGS. 21(a) and 21(b), FIGS. 22(a) and 22(b), FIGS. 23(a) and 23(b), and FIGS. 24(a) and 24(b). FIGS. 21(a) and 21(b) illustrate the thin-wall portion 62 formed by the cylindrical recess. In FIGS. 22(a) and 22(b), the thin-wall portion 62 is obtained by forming a spherical recess. In FIGS. 23(a) and 23(b), the thin-wall portion 62 is obtained by forming an inverted-circular-truncated-cone-shaped recess. In FIGS. 24(a) and 24(b), the thin-wall portion 62 is obtained by forming a conical recess.

When a step is formed in the same size, the leakage of the light from the surrounding of the thin-wall portion 62 is decreased as an angle formed by the thin-wall portion 62 and a flat portion out of the thin-wall portion 62 of the light guide sheet 15 becomes geometrically shallow, and an influence on the look as the key illumination module is decreased. Accordingly, when the thin-wall portion 62 does not have a flat bottom surface, although an allowable range of a position deviation from the apex of the contact spring 13 of the cross-shaped slit 18 is narrowed, the key illumination switch looks good and an optical advantage is obtained. Therefore, the thin-wall portion 62 having the suitable shape may be used according to applications.

(Deviation Between Slit and Contact Spring)

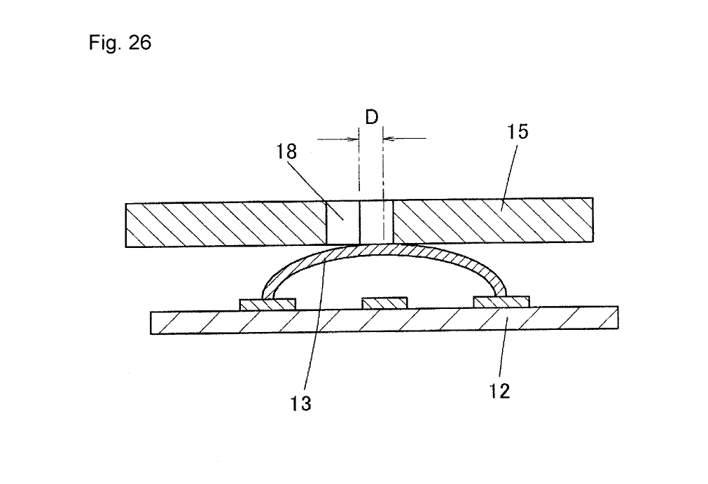

Although the center of the slit 18 provided in the light guide sheet 15 is desirably aligned with the apex of the contact spring 13, some deviations are allowable as illustrated in FIG. 26. Therefore, an allowable amount of a deviation D between the center of the slit 18 and the apex of the contact spring 13 was investigated.

The state in which the center of the slit 18 formed in the light guide sheet 15 was disposed in the center of the contact spring 13 was set to a reference position to evaluate how much the position deviation D of the slit 18 was allowable. The evaluation was performed by the click rate, and a range where the decrease in click rate was within 5% (click rate of 26% or more) from the use of the light guide sheet without the slit (click rate 31%) was set to the allowable range. The light guide sheet including the cross-shaped slit whose slit length B was 2 mm was used as a test sample. The contact spring 13 had the diameter of 4 mm.

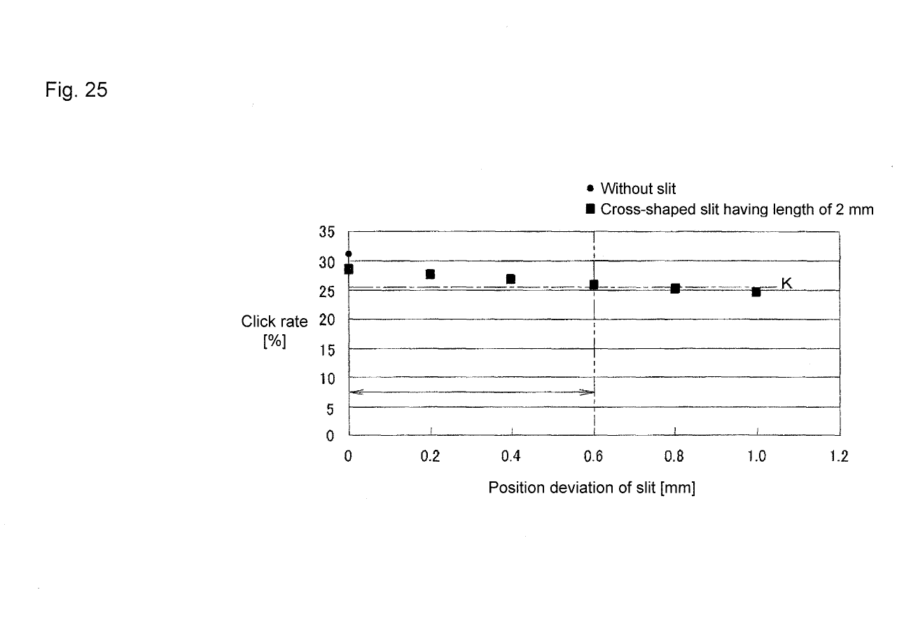

FIG. 25 illustrates a relationship between a position deviation D of the slit 18 and the click rate, and a line K expresses an allowable limit in which the click rate is decreased by 5%. According to the evaluation result, the position deviation of ±0.6 mm or less is allowable in the slit 18. Because the contact spring 13 has the diameter A of 4 mm, the allowable value means that the center of the slit 18 falls within the circular region, in which the apex of the contact spring 13 is set to the center while the length of 3/20 times the diameter A of the contact spring 13 is set to the radius. It is determined that the position deviation of ±0.6 mm or less is sufficiently practical level compared with a mounting deviation of ±0.2 mm of the contact spring 13 and a mounting deviation of ±0.2 mm of the light guide sheet 15.

In the fifth embodiment, when the thin-wall portion 62 is provided in the light guide sheet 15, the thin-wall portion 62 has the flat bottom surface as illustrated in FIGS. 21(a) and 21(b) and FIGS. 23(a) and 23(b). In such cases, the allowable position deviation of the cross-shaped slit 18 from the center of the contact spring 13 falls within 15% of the diameter A of the contact spring 13. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### EXPLANATION OF SYMBOLS

11, 41 key illumination switch module

12 printed wiring board

13 contact spring

14 cover sheet

15 light guide sheet

16a first fixed contact

16b second fixed contact

17 adhesive layer

18 slit

20 light source

23 light outgoing surface

24 light deflection pattern

25 light guide sheet

31 mobile telephone

32 key top

34 key

43 pusher

44 adhesive layer

51 light shielding layer

62 thin-wall portion

1. A key illumination switch module comprising:
a cover sheet that includes an adhesive layer in a rear surface thereof;
a dome-shaped contact spring whose apex portion is bonded to a rear surface of the cover sheet by the adhesive layer;
a board that includes a first fixed contact and a second fixed contact, the first fixed contact and the second fixed contact being switched between a conducting state and an insulated state by the contact spring; and
a light guide sheet that is disposed on a surface side of the cover sheet,
wherein, in the light guide sheet, a through-hole is made at a position corresponding to the apex portion of the contact spring.

2. A key illumination switch module comprising:
a light guide sheet that includes an adhesive layer in a rear surface thereof;
a dome-shaped contact spring whose apex portion is bonded to the rear surface of the light guide sheet by the adhesive layer; and
a board that includes a first fixed contact and a second fixed contact, the first fixed contact and the second fixed contact being switched between a conducting state and an insulated state by the contact spring,
wherein, in the light guide sheet, a through-hole is made at a position corresponding to the apex portion of the contact spring.

3. The key illumination switch module according to claim 1, wherein the through-hole is made by slit processing.

4. The key illumination switch module according to claim 3, wherein the through-hole made by the slit processing has a gap between sidewall surfaces located opposite each other in the through-hole.

5. The key illumination switch module according to claim 1, wherein the through-hole is made into a cross shape by slit processing.

6. The key illumination switch module according to claim 5, wherein a slit length of the cross-shaped through-hole ranges from 0.1 mm to 4 mm.

7. The key illumination switch module according to claim 1, wherein a center of the through-hole falls within a circular region when viewed from a direction perpendicular to the light guide sheet, an apex of the contact spring being set to a center of the circular region, a radius of the circular region being set to a length 3/20 times a diameter of the contact spring.

8. The key illumination switch module according to claim 1, wherein a diameter of a circle circumscribed to the through-hole is smaller than a diameter of the contact spring when viewed from a direction perpendicular to the light guide sheet.

9. The key illumination switch module according to claim 1, wherein a light shielding treatment is performed to a sidewall surface in the through-hole.

10. The key illumination switch module according to claim 1, wherein a sheet thickness of a region corresponding to the through-hole in the light guide sheet ranges from 0.1 times to 0.9 times a sheet thickness of a region located far away from the region corresponding to the through-hole.

11. A light guide sheet wherein a through-hole is made by slit processing.

12. The light guide sheet according to claim 11, wherein the through-hole made by the slit processing has a gap between sidewall surfaces located opposite each other in the through-hole, the gap ranging from 0.1 mm to 0.5 mm.

13. The light guide sheet according to claim 11, wherein the through-hole is made into a cross shape by slit processing.

14. The light guide sheet according to claim 11, wherein a slit length of the cross-shaped through-hole ranges from 0.1 mm to 4 mm.

15. The light guide sheet according to claim 11, wherein the light guide sheet is used to bond a dome-shaped contact spring to a rear surface of a cover sheet disposed on a rear surface side by an adhesive agent layer, and
a diameter of a circle circumscribed to the through-hole is smaller than a diameter of the contact spring when viewed from a perpendicular direction.

16. The light guide sheet according to claim 11, wherein
the light guide sheet is used to bond a dome-shaped contact spring to a rear surface thereof by an adhesive agent layer, and
a diameter of a circle circumscribed to the through-hole is smaller than a diameter of the contact spring when viewed from a perpendicular direction.

17. The light guide sheet according to claim 11, wherein a light shielding treatment is performed to a sidewall surface in the through-hole.

18. The light guide sheet according to claim 11, wherein a sheet thickness of a region corresponding to the through-hole in the light guide sheet ranges from 0.1 times to 0.9 times a sheet thickness of a region located far away from the region corresponding to the through-hole.

19. The key illumination switch module according to claim 2, wherein the through-hole is made by slit processing.

20. The key illumination switch module according to claim 19, wherein the through-hole made by the slit processing has a gap between sidewall surfaces located opposite each other in the through-hole.
